(19) United States
(12) Patent Application Publication
(10) Pub. No.: US 2023/0412712 A1
(43) Pub. Date: Dec. 21, 2023

(54) PACKET HEADER OPTIMIZATION IN ETHERNET INTERNET PROTOCOL NETWORKS

(71) Applicant: Intel Corporation, Santa Clara, CA (US)

(72) Inventors: Nayan Suthar, Bangalore (IN); Mark Debbage, Santa Clara, CA (US); Ramnarayanan Muthukaruppan, Fremont, CA (US)

(73) Assignee: Intel Corporation, Santa Clara, CA (US)

(21) Appl. No.: 18/459,688

(22) Filed: Sep. 1, 2023

(30) Foreign Application Priority Data
May 26, 2023 (IN) 202341036641

(51) Int. Cl. H04L 69/22; H04L 45/74

(52) U.S. Cl. CPC H04L 69/22; H04L 2212/00; H04L 45/74

(57) ABSTRACT

Described herein are optimized packet headers for Ethernet IP networks and related methods and devices. An example packet header includes a field comprising a source identifier (SID), the SID comprising a shortened representation of a complete Internet Protocol (IP) address of a source network device, a field comprising a destination identifier (DID), the DID comprising a shortened representation of a complete IP address of a destination network device, and a field having a total number of bits that is less than 8 and comprising a shortened representation of a type of encapsulation protocol for the packet. The packet header excludes fields comprising the complete IP address and a media access controller (MAC) address of the source network device, fields comprising the complete IP address and the MAC address of the destination network device, a field comprising a header checksum, and a field comprising a total size of the packet.

### BACKGROUND

This application claims the benefit of and priority from India Provisional Patent Application No. 202341036641, filed May 26, 2023, entitled “PACKET HEADER OPTIMIZATION IN ETHERNET INTERNET PROTOCOL NETWORKS,” hereby incorporated by reference in its entirety.

### BACKGROUND

Networks enable computers and other devices to communicate. For example, networks can carry data representing video, audio, e-mail, and so forth. Typically, data sent across a network is carried by smaller messages known as packets. By analogy, a packet is much like an envelope you drop in a mailbox. A packet typically includes “payload” and a “packet header.” The packet's “payload” is analogous to the letter inside the envelope. Sometimes, a larger message may be broken up to be sent as payload of multiple packets, in which case a packet's “payload” is analogous to a portion of a letter. The packet's “packet header” is much like the information written on the envelope itself. The packet header can include information to help network devices handle the packet appropriately.

### BRIEF DESCRIPTION OF THE DRAWINGS

FIG. 1 illustrates an example architecture of a computing system according to an embodiment.

FIG. 2 illustrates an example architecture of a network interface device according to an embodiment.

FIG. 3 illustrates an example architecture of a computing system with a network interface device in the form of an Infrastructure Processing Unit (IPU) according to an embodiment.

FIG. 4 illustrates an example switch according to an embodiment.

FIG. 5 provides a schematic illustration of generating a shortened representation of an Internet Protocol (IP) address to be included in an optimized packet header according to an embodiment.

FIG. 6 provides a table illustrating values of an external packet header field to be included in an optimized packet header according to an embodiment.

FIGS. 7-9 illustrate examples of optimized packet headers according to different embodiments.

FIG. 10 provides a block diagram of an apparatus that may be used in processing packets with optimized packet headers according to an embodiment.

### DETAILED DESCRIPTION

Disclosed herein are optimized packet headers for Ethernet IP networks and related methods and devices. The systems, methods, and devices of this disclosure have several innovative aspects, no single one of which is solely responsible for the desirable attributes disclosed herein. Details of one or more implementations of the subject matter described in this specification are set forth in the description below and the accompanying drawings.

For the purpose of illustrating packet header optimization in Ethernet IP networks and related methods and devices as described herein, it might be useful to first understand phenomena that may come into play in certain packet-based networks. The following foundational information may be viewed as a basis from which the present disclosure may be properly explained. Such information is offered for purposes of explanation only and, accordingly, should not be construed in any way to limit the broad scope of the present disclosure and its potential applications.

Current Ethernet and IP packets have relatively large packet headers, which may be detrimental to the efficiency of packets that have small payloads. Taking as an example Ethernet-II at Layer 2 and IP at Layer 3 as examples of communication protocols used in wired networks, one of the common packet formats used in IP version 4 (IPv4) may employ packet headers with as many as 40 to 60 bytes. Some applications such as high-performance computing (HPC), partitioned global address space (PGAS), or voice over IP (VoIP) employ packets with payloads that may be of comparable size or smaller than their packet headers. Such applications are commonly referred to as “small-payload” or “small-packet” applications. For example, a VoIP packet may carry a 20-byte payload and a 40-byte packet header, which means that the payload only accounts for only about 33% of the packet. Low payload-to-packet header ratios add significant overhead at various layers, which may lead to serious impairment of bandwidth utilization and delay.

The term “packet header compression” refers to reducing the size of a packet header. Some examples of conventional packet header compression techniques include Robust Packet header Compression (ROHC), Request For Comments (RFC) 2508, RFC 1144, and RFC 6282. Out of these, ROHC, RFC 2508, and RF 1144 are schemes for stateful compression of packet headers. RFC6282 is a scheme that can be stateful and stateless, but it is specific to IP version 6 (IPv6) and low power wireless networks. Thus, conventional packet header compression techniques are either stateful (point-to-point and rely on back-to-back packets with near identical packet headers), limited to IP/TCP/UDP packet headers, or specific to low power wireless networks.

Embodiments of the present disclosure are based on recognition that there are fields in conventional Ethernet IP packet headers that are not always used and can, therefore, be eliminated or shortened. In particular, packer headers proposed herein include proper subsets of Ethernet and IPv4 header fields of conventional packet headers, where the term “proper subset” of a set X is a subset of X that is not equal to X. Embodiments presented herein optimize Media Access Control (MAC) and IP packet headers in a manner that is stateless and end to end. In particular, proposed embodiments involve optimizing the fields of Ethernet MAC and IPv4 packet header to form packet headers with reduced sizes. The reduced packet header size may increase the payload-to-packet header ratio and, consequently, improve efficiency of packets. Embodiments presented herein may be particularly beneficial to small-packet applications.

Message Passing Interface (MPI) is a standardized and portable message-passing system designed for parallel and distributed computing. MPI provides a set of rules, conventions, and libraries that enable processes running on different computing nodes, clusters, or processors to communicate and synchronize with each other. MPI is widely used in HPC and scientific computing to develop parallel and distributed applications. Reducing the size of packets by implementing embodiments of the present disclosure could improve the performance of MPI applications in some use cases.

Embodiments presented herein involve new packet header definitions, which may necessitate changes to hardware, software, and/or configuration compared to existing designs. Use of the optimized packet headers presented herein is optional, and the initiating device may pick these optimized formats for packets where optimizations would not impact packet delivery. The rest of the traffic can continue to use existing formats. Network devices such as switches, switch chips, switch system-on-a-chip (SoC), and routers may be configured to support both new and existing packet header formats.

Two sets of embodiments for packet header optimization are presented herein, referred to as “option A” and “option B.” Network devices may be configured to implement either one or both of these options, depending on deployment scenarios and goals. One or more fields in an optimized packet header may be used to indicate whether embodiments of option A, embodiments of option B, or a combination of embodiments of option A and option B is used. Common to both sets of embodiments, an example packet header according to one aspect of the present disclosure includes a field comprising a source identifier (SID), the SID comprising a shortened representation of a complete IP address of a source network device, a field comprising a destination identifier (DID), the DID comprising a shortened representation of a complete IP address of a destination network device, and a field having a total number of bits that is less than 8 and comprising a shortened representation of a type of encapsulation protocol for the packet. The packet header excludes fields comprising the complete IP address and a MAC address of the source network device, fields comprising the complete IP address and the MAC address of the destination network device, a field comprising a header checksum, and a field comprising a total size of the packet.

For the purposes of the present disclosure, the terms “processing circuitry” or “processor” refer to constructs able to process data, such as processes, threads, virtual machines, and field programmable gate array (FPGA) programs. A “computing unit” includes any physical component, or logical arrangement of physical components, capable of processing a portion of a packet or an entirety of a packet. Example computing units include, but are not limited to a computer processing unit (CPU), a core, a CPU complex, a server complex, an FPGA, an application specific integrated circuit (ASIC), a graphics processing unit (GPU), or other co-processors. A “memory circuitry” or, simply, “memory” as used herein, e.g., used in the context of a server, includes a memory structure which may include at least one of a buffer, a cache (such as a L1, L2, L3 or other level cache including last level cache), an instruction cache, a data cache, a first in first out (FIFO) memory structure, a last in first out (LIFO) memory structure, a time sensitive/time aware memory structure, a ternary content-addressable memory (TCAM) memory structure, a register file such as a nanoPU device, a tiered memory structure, a two-level memory structure, a memory pool, or a far memory structure, to name a few.

In the following figures, like components will be referred to with like and/or the same reference numerals. Therefore, detailed description of such components may not be repeated from figure to figure.

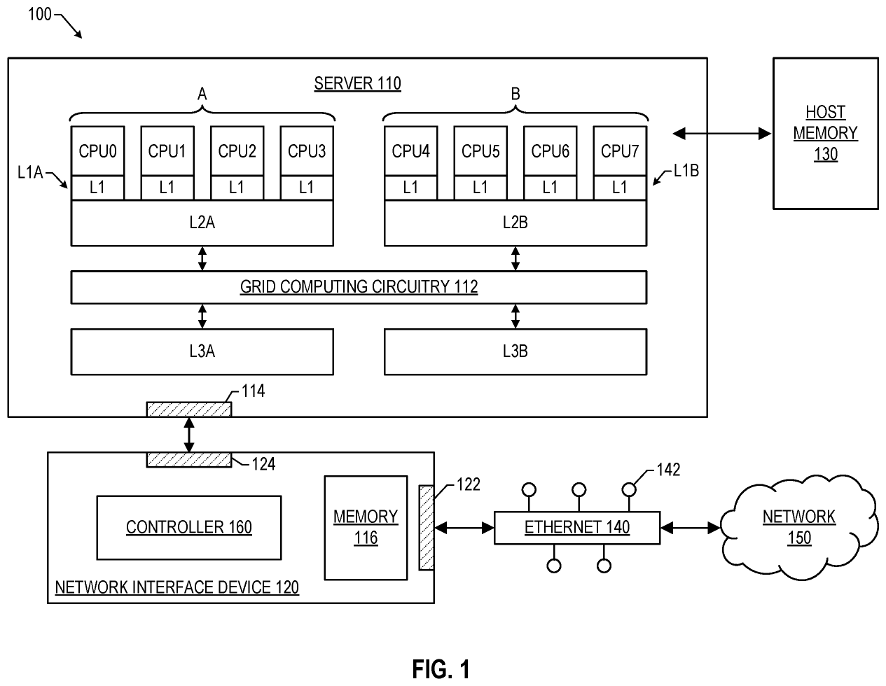

FIGS. 1-4 show examples architectures relating to various aspects of a computing network, such as a datacenter, in which optimized packet headers as described herein may be processed (e.g., generated, received, transmitted, or processed in any other manner) according to some embodiments.

FIG. 1 illustrates an example computing system 100 of a datacenter. As shown in FIG. 1, the computing system 100 includes a server 110 (or, more generally, a host) coupled to a network interface device 120 and a host memory 130.

In some embodiments, the server 110 may include two or more subsystems of computing units (e.g., CPUs) and their associated caches L1-L3. For example, as shown in FIG. 1, in an embodiment, the server 110 may include two subsystems, A and B. The subsystem A may include CPUs 0, 1, 2, and 3, where different CPUs may be associated with a respective local L1 cache (where, together, the L1 caches of subsystem A are labeled in FIG. 1 as caches L1A), and their L2 cache L2A. Similarly, the subsystem B may include CPUs 0, 1, 2, and 3, where different CPUs may be associated with a respective local L1 cache (where, together, the L1 caches of subsystem B are labeled in FIG. 1 as caches L1B), and their L2 cache L2B. In the embodiment shown in FIG. 1, the L2 caches are shared by a plurality, e.g., all, CPUs of a subsystem. The L3 caches L3A and L3B are also specific to a given subsystem in the example of FIG. 1, although there could be a single L3 cache that is shared by a plurality, e.g., all, CPUs of the server 110. L3 caches tend to be very large in terms of area, especially when they are shared among multiple subsystems of a server.

For the subsystems A and B, the L3 cache is shown in FIG. 1 as being coupled to its respective L2 cache by way of a grid computing circuitry 112 (e.g., a UNCORE (Uniform Interface to Computing Resources)). The grid computing circuitry 112 may create target system specific actions from an XML workload description (Abstract Workload Objects, AWO) received from a client of the computing system. Available grid computing circuitry services may include workload submission and workload management, file access, file transfer (both client-server and server-server), storage operations, and workflow submission and management. In other embodiments, the grid computing circuitry 112 may be absent from the server 110 and the L3 caches of the individual subsystems of the server 110 may be coupled to their respective L2 cache by other means or directly.

Although two subsystems as shown in FIG. 1, an individual subsystem having four CPUs, in general, the server 110 may include any number of subsystems with an individual subsystem including any number of computing units such as CPUs and any number of associated memory circuitries (e.g., caches) in any configuration.

The server 110 may include a server interface 114, using at least one of a bus, Peripheral Component Interconnect (PCI), PCI express (PCIe), PCIx, Universal Chiplet Interconnect Express (UCle), Intel On-chip System Fabric (IOSF), Gen-Z, Open Coherent Accelerator Processor Interface (OpenCAPI), and/or Compute Express Link (CXL), Serial ATA, and/or USB compatible interface (although other interconnection standards may be used). The server interface 114 is to couple the server 110 to the network interface device 120 to communicate data signals and control signals therebetween. Therefore, the server interface 114 may alternatively be referred to as a “network interface device interface.”

The network interface device 120 may, for example, be an IPU or a network interface controller (NIC). The network interface device 120 may include a network interface 122 which is connected to Ethernet 140. The Ethernet 140 may connect the computing system 100 to a network 150 including client devices (not shown). The network 150 may be an IP network and, therefore, together, the Ethernet 140 and the network 150 may be referred to as an “Ethernet IP network.” As shown in FIG. 1, the Ethernet 140 may further connect the computing system 100 to ports 142, which may connect to further devices, e.g., further client devices (not shown). At the other end of the network interface device 120, a server interface 124 may connect the network interface device 120 with the server 110. The server interface 124 is to communicate with server interface 114 of the server 110, e.g., using a communication protocol compatible with (e.g., the same as) that of the server interface 114. Between the network interface 122 and the server interface 124, a controller 160 may be used to control a flow of signals within the network interface device 120, for example by routing data packets (e.g., packets with optimizer packet headers as described herein) between the network 150 and the server 110. The controller 160 may implement, for example, a FleXible Parser (FXP), or one or more of many different other protocols (e.g., RDMA, NVMe, Encryption, etc.), as well as packet storage and decryption. In the ingress direction, the controller 160 may be configured to place the data at various locations in the host memory 130.

The controller 160 may perform operations on a packet, such as encapsulate/decapsulate, encrypt/decrypt, generate/modify/add/remove packet headers, aggregate/split, schedule packets and queues, etc., perform operations relating to a state of the packet, such as save/update metadata, change internal or system configurations to handle packet processing, query/use stored metadata, query/use current or historical state of network interface device or system, request/schedule network interface device and system-level state changes (e.g., pre-load caches, load FPGA code in either on-network interface device FPGA or server FPGA, or both, etc.). In particular, the controller 160 of the network interface device 120 may perform any of these operations on the packets with optimized packet headers as described herein. However, more generally, any component/portion of the network interface device 120 may perform any of the operations on the packets with optimized packet headers as described herein. In some embodiments, a component/portion of the network interface device 120 may perform any of the operations on the packets with optimized packet headers as described herein under a control of an operating system and/or a device driver.

A memory 116 in the network interface device 120 may be used to act as a storage space set aside for storing packet queues received from the server 110 or from the network 150. The memory 116 may include any type of volatile or non-volatile memory device, such as one or more buffers, and can store any queue or instructions used to program any of the components of the network interface device 120. For example, the memory 116 may store any queue or instructions used to program any of the interfaces of the network interface device 120 (e.g., the network interface 122 and/or the server interface 124). In another example, the memory 116 may store any queue or instructions used to program the controller 160 (e.g., the memory 116 may store any queue or instructions used to process the optimized packet headers as described herein).

As packets are received by the controller 160, they may be parsed and stored in a packet buffer, which may be included in the memory 116. The controller 160 may inspect the contents of the incoming packet using packet inspection mechanisms, for example, using a TCP Offload Engine (TOE) and corresponding features. Looking up the layers in the packet's encapsulation, the controller 160 may be able to determine the source network device (e.g., a network device that sent the packet), the destination network device (e.g., a network device that is the destination of the packet), traffic-handling and metadata markings, application, or even the data contents. The packet inspection performed by the controller 160 does not have to be deep packet inspection. In some implementations it could be as simple as looking at the source address/port number/other packet header information and knowing that traffic from this source address/port number/packet header information needs to be processed using a particular program or processing element, and may correspond to a given workload/process/instruction to be executed.

Information obtained during the process of packet analysis may be stored in a metadata database, which, similar to a packet buffer, may also be included in the memory 116. The metadata database may store various metadata about a packet or group of packets. For example, the metadata database may include a service associated with the workload corresponding to the data packet, number of received packets of certain type, a program needed to process the packet or similar packets, a virtual machine needed to process the packet or similar packets, an FPGA program to process the packet or similar packets, a statistical profile of the packet or similar packets, and the like. The metadata database may be used by the controller 160 to manage coordination, scheduling, loading, and unloading of host queues (e.g., queues including control signals and/or data signals from the host) and/or network queues (e.g., queues including control signals and/or data signals from the network 150). The metadata database may further be used by the controller 160 in order to manage data routing operations to route data to a selected/determined physical location of a cache in the server 110.

In some embodiments, the controller 160 may implement coordinated scheduling of host or network queues. The coordinated scheduling may be used to determine proper scheduling decisions.

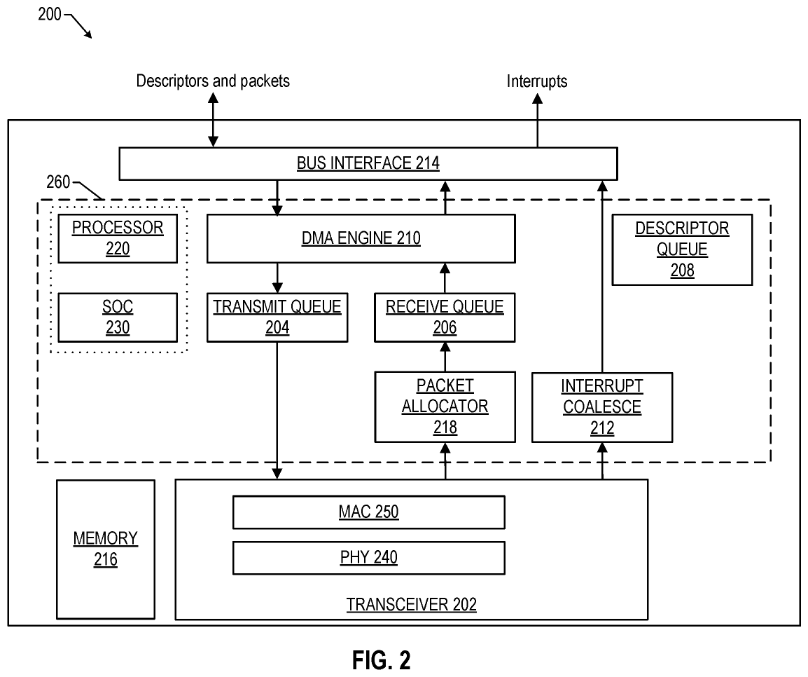

FIG. 2 illustrates an example architecture of a network interface device 200 according to an embodiment. The network interface device 200 may be an example of the network interface device 120 of FIG. 1, and vice versa (e.g., the network interface device 120 of FIG. 1 may be an example of the network interface device 200 of FIG. 2). In some examples, network interface device 200 can be implemented as a NIC, a host fabric interface (HFI), or a host bus adapter (HBA), and such examples can be interchangeable. The network interface device 200 can be coupled to one or more servers (e.g., the server 110 of FIG. 1) using a bus, PCIe, CXL, or a double-data rate (DDR) interface. Network interface device 200 may be embodied as part of an SoC that includes one or more processors, or included on a multichip package that also contains one or more processors.

Some examples of network interface device 200, similar to the network interface device 120 of FIG. 1, may be part an IPU or a data processing unit (DPU) or utilized by a network interface device or DPU. A general term “xPU” can refer at least to a network interface device, IPU, DPU, GPU, GPGPU, edge processing unit (EPU), or other processing units (e.g., accelerator devices). A network interface device 200 in the form of an xPU can include a network interface with one or more programmable or fixed function processors to perform offload of operations that could have been performed by a CPU. The network interface device 200 can include one or more memory devices (e.g., the memory 116 of FIG. 1). In some examples, the network interface device 200 can perform virtual switch operations, manage storage transactions (e.g., compression, cryptography, virtualization), and manage operations performed on other network interface devices, servers, or devices.

As shown in FIG. 2, the network interface device 200 may include a transceiver 202, a transmit queue 204, a receive queue 206, descriptor queues 208, direct memory access (DMA) engine circuitry 210, interrupt coalesce circuitry 212, a bus interface 214, memory 216, and packet allocator circuitry 218. In some embodiments, the transmit queue 204, the receive queue 206, the descriptor queues 208, the DMA engine circuitry 210, and the interrupt coalesce circuitry 212, and packet allocator circuitry 218 and may be part of a controller 260. The controller 260 may be an example of the controller 160 of FIG. 1, and vice versa. The memory 216 may be an example of the memory 116 of FIG. 1, and vice versa. If the network interface device 200 is an xPU, it may further include a processor 220 and a SoC 230 shown inside dotted lines in FIG. 2.

The transceiver 202 may be capable of receiving and transmitting packets in conformance with the applicable protocols such as Ethernet as described in IEEE 802.3, although other protocols may be used. The transceiver 202 can receive and transmit packets from and to a network (e.g., the network 150 of FIG. 1) via a network medium (not depicted). To that end, the transceiver 202 may include PHY circuitry 240 and MAC circuitry 250. The PHY circuitry 240 may include encoding and decoding circuitry (not shown) to encode and decode data packets according to applicable physical layer specifications or standards. The MAC circuitry 250 may be configured to assemble data to be transmitted into packets, which include destination and source addresses along with network control information and error detection hash values.

The transmit queue 204 may include data or references to data for transmission by a network interface of the network interface device 200. The receive queue 206 may include data or references to data that was received by a network interface of the network interface device 200 from a network. The descriptor queues 208 may include descriptors that reference data or packets in the transmit queue 204 or the receive queue 206. A descriptor may provide information on a packet, such as the source and target memory addresses of the packet and the length of the packet in memory. A descriptor, once posted to the DMA engine circuitry 210, may trigger the DMA engine circuitry 210 to generate a DMA request to fetch the packet from an external memory.

The bus interface 214 may provide an interface with a server (e.g., the server 110 of FIG. 1), e.g., the bus interface 214 may be an example of the server interface 124 of FIG. 1. In various embodiments, the bus interface 214 may be compatible with at least one of Peripheral Component Interconnect (PCI), PCI express (PCIe), PCIx, Universal Chiplet Interconnect Express (UCle), IOSF, Gen-Z, OpenCAPI, and/or Compute Express Link (CXL), Serial ATA, and/or USB compatible interface (although other interconnection standards may be used).

The DMA engine circuitry 210 may be configured to copy a packet header, packet payload, and/or descriptor directly from host memory to the network interface device or vice versa, instead of copying the packet information to an intermediate buffer at the host and then using another copy operation from the intermediate buffer to the destination buffer, hence the “direct” in the term “DMA”.

The interrupt coalesce circuitry 212 may be configured to perform interrupt moderation whereby a network interface the interrupt coalesce circuitry 212 may wait for multiple packets to arrive, or for a time-out to expire, before generating an interrupt to host system to process received packet(s). In some embodiments, Receive Segment Coalescing (RSC) may be performed by a network interface of the network interface device 200 whereby portions of incoming packets are combined into segments of a packet. The network interface device 200 may then be configured to provide such a coalesced packet to an application.

The packet allocator circuitry 218 may be configured to provide distribution of received packets for processing by multiple computing units, such as CPUs 0 to 7 of FIG. 1, or cores, and can do so using packet data allocation to various cache physical locations on a server, such as the server 110 of FIG. 1. When the packet allocator circuitry 218 uses receive side scaling (RSS), it may calculate a hash or make another determination based on contents of a received packet to determine which CPU or core is to process the packet. The latter provides one example of implementation regarding allocation of a packet to a CPU, but also, additionally and in a related manner, to an embodiment where the packet allocator circuitry 218 is adapted to manage data routing operations by selecting cache physical locations for the storage of packet data according to an embodiment. In some embodiments, the packet allocator circuitry 218 could be included within the processor 220. In other embodiments, the packet allocator circuitry 218 may be separate from the processor 220.

The processor 220 may be any a combination of a processor, core, GPU, FPGA, ASIC, or other programmable hardware devices that allow programming of functionality of various components of the network interface device 200. For example, a “smart network interface” can provide packet processing capabilities in the network interface device 200 using the processor 220. The processor 220 may include one or more packet processing pipeline that can be configured to perform match-action on received packets to identify packet processing rules and next hops using information stored in a TCAM tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., RSS), a packet modifier (modifier), or traffic manager (e.g., transmit rate metering or shaping). For example, packet processing pipelines can implement access control list (ACL), or packet drops due to queue overflow. Configuration of operation of the processor 220, including its data plane, may be programmed using Programming Protocol-independent Packet Processors (P4), C, Python, Broadcom Network Programming Language (NPL), Infrastructure Programmer Development Kit (IPDK), or x86 compatible executable binaries or other executable binaries. The processor 220 and/or the SoC 230 may be configured to execute instructions to configure and utilize one or more circuitry as well as check against violation against use configurations, as described herein.

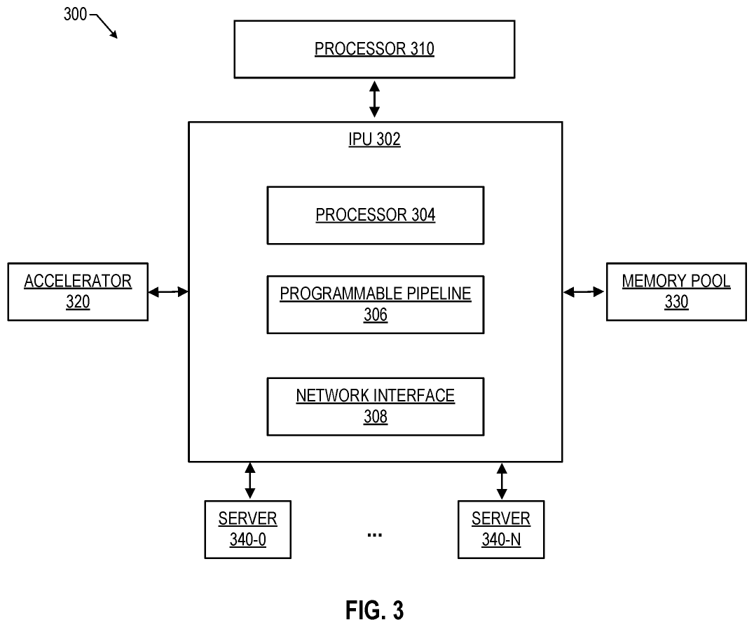

FIG. 3 depicts an example of a communication system 300 with a network interface device in the form of an IPU 302 that may be used to implement some embodiments. The IPU 302 may be an example of the network interface device 120 of FIG. 1, and vice versa. The IPU 302 may be an example of the network interface device 200 of FIG. 2, and vice versa. The IPU 302 may be configured to manage performance of one or more processes using one or more of processors 304, processors 310, accelerators 320, memory pool 330, or servers 340-0 to 340-N, where N is an integer equal to or greater than 1. In some examples, processors 304 of the IPU 302 can execute one or more processes, applications, VMs, containers, microservices, and so forth that request performance of workloads by one or more of: processors 310, accelerators 320, memory pool 330, and/or servers 340-0 to 340-N. The IPU 302 may be configured to utilize a network interface 308 or one or more device interfaces to communicate with the processors 310, the accelerators 320, the memory pool 330, and/or the servers 340-0 to 340-N. The IPU 302 may be configured to utilize a programmable pipeline 306 to process packets that are to be transmitted from the network interface 308 or packets received from the network interface 308.

In some examples, configuration of the programmable pipeline 306 may be programmed using a processor of the processors 304 and operation of the programmable pipeline 306 can continue during updates to software executing on the processor, or other unavailability of the processor, as a second processor of the processors 304 may provide connectivity to a host such as one or more of servers 340-0 to 340-N and the second processor can configure operation of the programmable pipeline 306.

Embodiments include within their scope an apparatus of a server of a computing network, the computing network including a host memory and a network interface device, the apparatus including one or more processors to generate a message including a timestamp to indicate a time at which the network interface device is to fetch, from a host memory, one or more data packet descriptors that correspond to the timestamp, and send the message for transmission to the network interface device.

Embodiments include within their scope an apparatus of a network interface device of a computing network, the computing network including a host memory and a server, the apparatus including one or more processors to access a message from the server, the message including a timestamp to indicate a time at which the network interface device is to fetch from a host memory one or more data packet descriptors that correspond to the timestamp; and send for transmission to the server a request to access the host memory to fetch the one or more data packet descriptors therefrom, the request to access based on the timestamp.

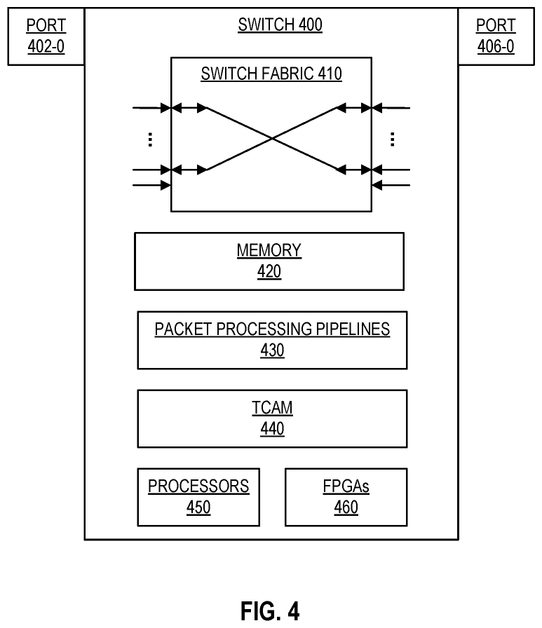

FIG. 4 illustrates an example switch 400 according to an embodiment. Various examples can be used in or with the switch 400 to perform an aggregation receiver, connect with worker nodes or switches, and/or communicate using reliable or non-reliable transport protocols, as described herein. The switch 400 can be implemented as a SoC. The switch 400 can route packets or frames of any format or in accordance with any specification from any port 502-0 to 502-X (together referred to as “ports 502”) to any of ports 506-0 to 506-Y (together referred to as “ports 506”), or vice versa. Any of the ports 502 can be connected to a network of one or more devices. Similarly, any of the ports 506 can be connected to a network of one or more interconnected devices.

In some embodiments, the switch 400 may include a switch fabric 510, configured to provide routing of packets from one or more ingress ports for processing prior to egress from the switch 400. The switch fabric 510 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

In some embodiments, the switch 400 may include a memory 420, configured to store packets received at ports prior to egress from one or more ports. The switch 400 may further include packet processing pipelines 430, configured to determine which one of the ports 502 or 506 to transfer packets or frames to using a table that maps packet characteristics with an associated output port. The packet processing pipelines 430 can be configured to perform match-action on received packets to identify packet processing rules and next hops using information stored in a TCAM table 440 or exact match tables in some examples. For example, match-action tables or circuitry can be used whereby a hash of a portion of a packet is used as an index to find an entry. The packet processing pipelines 430 can implement ACL or packet drops due to queue overflow. The packet processing pipelines 430 can be configured to perform an aggregation receiver, connect with worker nodes or switches, and/or communicate using reliable or non-reliable transport protocols, as described herein. Configuration of operation of the packet processing pipelines 430, including its data plane, can be programmed using P4, C, Python, Broadcom NPL, or x86 compatible executable binaries or other executable binaries. In some embodiments, the switch 400 may include processors 450 and FPGAs 460 for packet processing or modification.

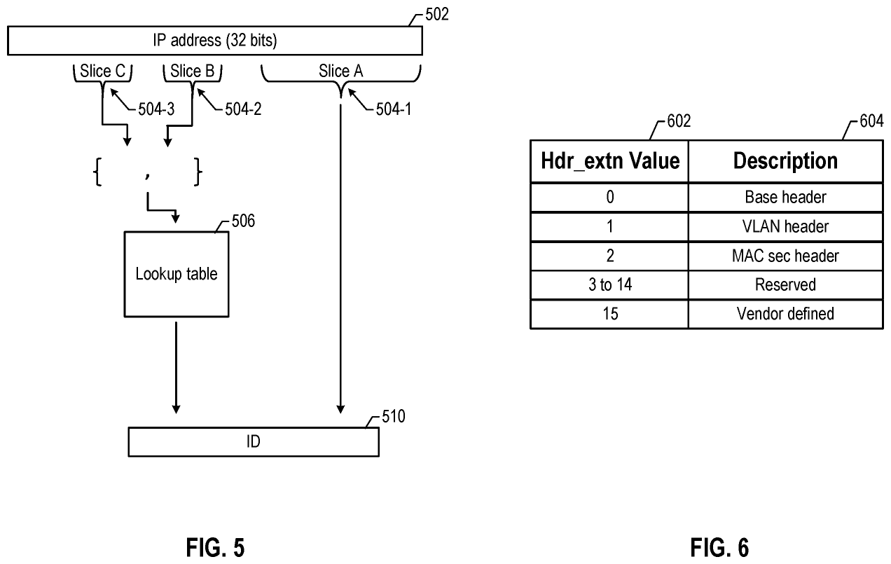

Any of the packets described with reference to FIGS. 1-4 may be packets with optimized packet headers as described herein. Components described with reference to FIGS. 1-4 as being involved in processing of packets may be configured to generate and/or interpret optimized packet headers as described herein, as well as transmit/forward or receive packets with such packet headers. Example embodiments of packets with optimized packet headers will now be described more particularly in the context of FIGS. 5-10 below.

When a packet is sent from a source network device to a destination network device, conventional packet headers use fields containing a MAC address and a complete IP address for the destination network device. These fields are used in identification of the destination and selecting the path to reach the destination. Similarly, conventional packet headers use fields containing a MAC address and a complete IP address for the source network device. These fields are used in identification of the source of the packet and the path to reach the source. In such conventional packet headers, the IP addresses have the complete identification of the end point. In contrast to such conventional implementations, packet header optimization according both option A and option B is based on recognition that, if elements in the network path are capable of routing based on IP addresses alone, then MAC addresses used in conventional packet headers are redundant and can be eliminated and only IP addresses are used to identify a source network device and a destination network device. Further in contrast to such conventional implementations, packet header optimization according both option A and option B is based on recognition that the complete IP addresses of the source and destination network devices may be shortened and that some other fields used in conventional packet headers may be either shortened or eliminated.

Conventionally, IP address fields are 32 bits. In contrast, packet header optimization according both option A and option B use shortened representations of IP addresses of source and destination network devices because target networks for implementing these packet header optimization techniques have a limited size and fewer bits are enough. FIG. 5 provides a schematic illustration of generating a shortened representation of an IP address to be included in an optimized packet header according to an embodiment. As shown in FIG. 5, starting with an IP address 502, which may be either an IP address of a source network device or a destination network device, and is a full IP address comprising 32 bits, two or more subsets 504 (which may also be referred to as “slices”), shown in FIG. 5 as subset A, subset B, and subset C, may be selected. As used herein, the term “subset” of an IP address refers to a sequence of consecutive bits of an IP address, which sequence is shorter than the full IP address. The subsets 504 selected from the IP address 502 may be selected arbitrary in that their selection may be controlled by a particular network configuration as long as considerations described herein are observed. The subsets 504 may be non-overlapping subsets of the IP address, as illustrated in FIG. 5 (e.g., for a given one of the subsets 504, none of the bits of the IP address 502 are overlapping with bits of the other subsets 504). The first subset 504-1 (shown as subset A in FIG. 4) may include a configurable number of bits that are lower order bits of the IP address 502. The second subset 504-2 (shown as subset B in FIG. 4) and the third subset 504-3 (shown as subset C in FIG. 4) may include bits of the IP address 502 that are higher order bits than the bits of the first slide 504-1. In some embodiments, the second subset 504-2 and the third subset 504-3 may be appended to index into a lookup table 506. In other words, the second subset 504-2 and the third subset 504-3 may be used as an input for the lookup table 506, and, based on such input, the lookup table may generate an output. Using the lookup table 506 may allow flexibility to cover multiple IP subnets, while using two (or more) subsets 504 for indexing in the lookup table 506 may help optimizing the size of the lookup table 506.

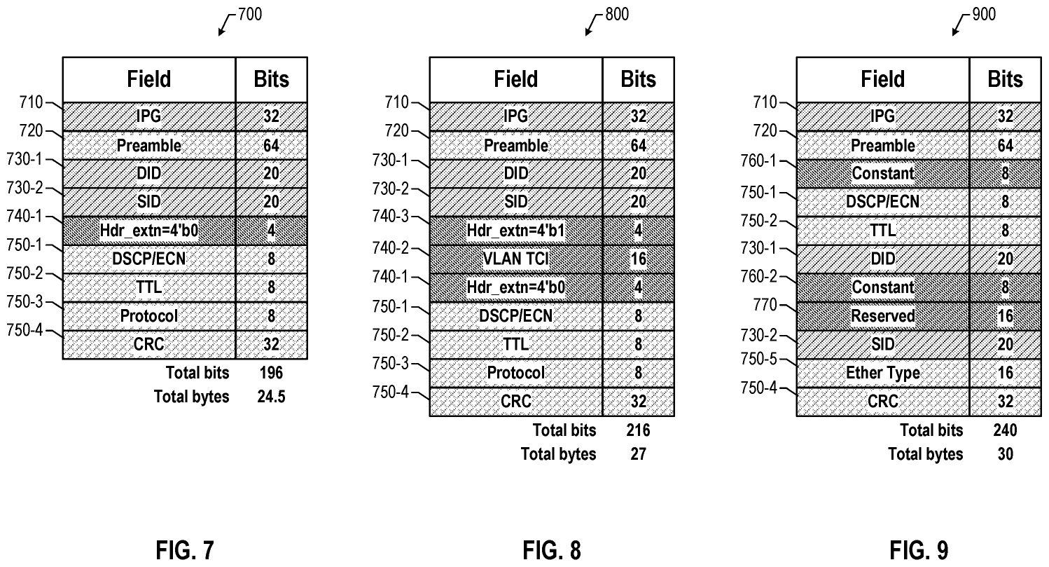

As further shown in FIG. 5, a shortened representation of the IP address, which may be referred to hereafter as an identification (ID) 510 may then be generated based on the bits of the first subset 504-1 and an output of the lookup table 506 when one or more other subsets 504 (e.g., the subsets 504-2 and 504-3) is/are provided thereto as an input. In some embodiments, the ID 510 may be generated by appending a configurable number of lower order bits of the output of the lookup table 506 to subset A to the first subset 504-1. For example, the output of the lookup table 506 may be an N-bit output, but only M lowest bits of the N-bit output may be appended to the first subset 504-1 to generate the ID 510, where M and N are integers greater than 1 and M is smaller than N. Such a process of generating the ID 510 is configurable, stateless, and reversible with appropriate configuration. The ID 510 generated for the IP address of the source network device may then be used in a field Source ID (SID) of an optimized packet header, and the ID 510 generated for the IP address of the destination network device may then be used in a field Destination ID (DID) of an optimized packet header, e.g., as shown in FIGS. 7-9 and described below. The SID and DID fields are new fields that may be used in optimized packet headers and may replace the old fields for MAC and full IP addresses used in conventional packet headers.

Another new field that may be used in optimized packet headers according to option A may be referred to as an extended packet header (Hdr_extn) field. FIG. 6 provides a table illustrating values of an extended packet header field to be included in an optimized packet header according to an embodiment. In conventional packet headers, the EtherType field of Ethernet-II packet header is used to indicate the type of encapsulated protocol, and for cascading additional packet headers (e.g., VLAN tags). The optimized packet headers proposed herein are targeted to specific deployment scenarios and, therefore, a smaller field called “Hdr_extn” may be sufficient. In some embodiments, such a field may be a 4-bit field. FIG. 6 illustrates how the values of this field (shown in column 602 of FIG. 6) may be mapped to the description of what the values mean (shown in column 604 of FIG. 6). In some embodiments, multiple such packet headers may cascade one after the other. In such embodiments, the base packet header may be mandatory, while other packet header types may be optional. In some embodiments, the base packet header may be arranged as the last packet header of a cascade of Hdr_extn fields.

FIGS. 7-9 illustrate three examples of optimized packet headers according to different embodiments of the disclosure. In FIGS. 7-9, the left column indicates fields that may be used in an optimized packet, while the right column indicates the number of bits allocated for a field. Furthermore, different patterns are used for different rows of the packet header formats shown in FIG. 9. These patterns are used to provide a visual illustration of fields that may be identical to the fields used in conventional packet headers (fields Preamble, DSCP/ECN, TTL, Protocol, and a checksum, e.g., a CRC, each shown with a first pattern), fields that are similar to those used in conventional packet headers but are shortened and include less bits (fields inter packet gap (IPG), DID, and SID, each shown with a second pattern), and fields that are new compared to the fields used in conventional packet headers (fields Hdr_extn=4′b0, VLAN TCI, Hdr_extn=4′b1, Constant, and Reserved, each shown with a third pattern).

FIG. 7 and FIG. 8 provide two examples of optimized packet headers according to option A, while FIG. 9 provides an example of an optimized packet header according to option B.

As shown in FIG. 7, a packet header 700 may include a field IPG, labeled as a field 710, that is shorter than that of conventional packet headers. In conventional packet headers the field IPG is a 96-bit field. One of the purposes of using the field IPG is to bridge the frequency parts per million (PPM) difference between the receiver and transmitter. PPM is a measure of frequency stability of clocks used, e.g., in the receiver and the transmitter of a packet. According to option A, an alternative mechanism may be used to solve this problem. The transmitter must send idle symbols with enough frequency to cover the maximum PPM difference supported by the standard. Using such an alternate mechanism may allow using only the minimum IPG required to satisfy the 8-byte alignment requirement for start of packet, which, in turn, allows reducing the size of the IPG field to less than 96 bits, e.g., to 32 bits as shown in FIG. 7.

A field Preamble of the packet header 700, labeled as a field 720, may be substantially the same as used in conventional implementations, except that now it may be used to indicate whether the packet uses the optimized format for the packet header or not, and/or what type of optimized format for the packet header is used (e.g., according to embodiments of option A, embodiments of option B, or a combination of these embodiments). Any suitable set of bits and encoding may be used to indicate the format of a packet header in the field Preamble, all of which being within the scope of the present disclosure. The field Preamble may be 74 bits in some embodiments.

Besides the IPG field, other fields that may be shortened in the packet header 700 compared to conventional packet headers are fields DID and SID, labeled as fields 730-1 and 730-2, respectively. In particular, the DID field 730-1 may include a shortened representation of the complete IP address of the destination network device, generated as described with reference to FIG. 5, while the SID field 730-2 may include a shortened representation of the complete IP address of the source network device, also generated as described with reference to FIG. 5. As shown in FIG. 7, any one of the SID and DID fields may be 20 bits in some embodiments. However, the exact number of bits used in the SID and DID fields may be implementation-dependent and may include any number smaller than 32 (e.g., smaller than the total number of bit of the full IP address). Furthermore, in some embodiments, the number of bits in SID and the number of bits in DID do not have to be equal.

As further shown in FIG. 7, a new field Hdr_extn, labeled as a field 340-1, may be included in the packet header 700. Values of this field may be as those described with reference to FIG. 6.

FIG. 7 further illustrates that the packet header 700 may include fields DSCP/ECN (labeled as a field 750-1), TTL (labeled as a field 750-2), Protocol (labeled as a field 750-3), and CRC (labeled as a field 750-4), which may be substantially the same as used in conventional implementations.

Fields of conventional packet headers not shown in FIG. 7 are those that may be eliminated to reduce the packet header size.

One of such fields is a field Version, typically included in IP (e.g., L3) packet headers of Ethernet IP packets. This field may be eliminated because the type of compressed packet header is selected based on the Preamble. The field Hdr_extn may then be used to create future variations of the compressed packet header.

Another field that may be omitted from the packet header 700 is a field IHL of conventional IP packet headers, indicating the length of the IP packet header. This field may be eliminated because the packet header length of the compressed packet header is deterministic and can be computed when needed.

Another field that may be omitted from the packet header 700 is a field Total Length of conventional IP packet headers. The receiver MAC can detect the total size of the packet, and the length information can be inferred from it.

Further fields of conventional packet headers which are not shown in FIG. 7 because they may be omitted are a field Identification, a field Flags, and a field Fragment Offset, related to IP fragmentation. The optimized packet header 700 may be used in scenarios where IP fragmentation is not required and, therefore, these fields may be eliminated.

Yet another field that may be omitted from the packet header 700 is a field Hdr chksum of conventional IP packet headers. Afield CRC of Ethernet-II covers the full packet including the compressed packet header, rendering the field Hdr_chksum unnecessary.

FIG. 7 illustrates a packet header that implements the optimizations described above. In other embodiments of the packet header 700, some, but not all, of these optimizations may be implemented. For example, in some embodiments, the packet header 700 may include the IPG field that is not shortened (e.g., the IPG field of the packet header 700 may be 96 bits, as used in conventional packet headers). In another example, in some embodiments, the packet header 700 may include one or more fields related to IP fragmentation, if the packet header 700 is to be used in scenarios where IP fragmentation is required.

FIG. 8 illustrates a packet header 800, which is a second example of an optimized packet header of option A according to an embodiment. The packet header 800 is substantially the same as the packet header 700, except that, besides the base packet header 740-1 that was included in the packet header 700, the packet header 800 further includes a VLAN TCI packet header (labeled as a field 740-2) and a Hdr_extn=4′b1 (labeled as a field 740-3).

FIG. 9 illustrates a packet header 900, which is an example of an optimized packet header of option B according to an embodiment. This may implement optimizations similar to those described for option A, but the fields are arranged to resemble an Ethernet-II packet header without having any explicit IP packet header as would be used in conventional packet headers. A specific value in select bits of a destination MAC (DMAC) address field can be used to indicate whether the packet uses the option B optimized packet header, or it is a regular Ethernet-II packet header.

As shown in FIG. 9, in the packet header 900, the DID and SID (fields 730-1 and 730-2) may be placed in the NIC section of the MAC address. Fields Constant (a field 760-1 used in the DMAC portion and a field 760-2 used in the source MAC (SMAC) portion, shown in FIG. 9) may include the leading bytes of the Organizationally Unique Identifier (OUI) section of the MAC addresses of, respectively, the destination and the source network devices. For example, the Constant value of 0x02 may indicate that the MAC address is a locally administered unicast address. The higher 6 bits of the Constant can be considered a version number. This may be changed in future to change the interpretation of rest of the fields. A field Reserved (field 770), which may be a 16-bit field, may be used for providing entropy bits for multipath routing.

As also shown in FIG. 9, in the packet header 900 the field EtherType field (field 750-5) of conventional packet headers may be retained. The field EtherType may be used to support standard 802.1Q tagging. A set of 16 EtherType values can be allocated to serve the same purpose as the 4-bit Hdr_extn field described herein.

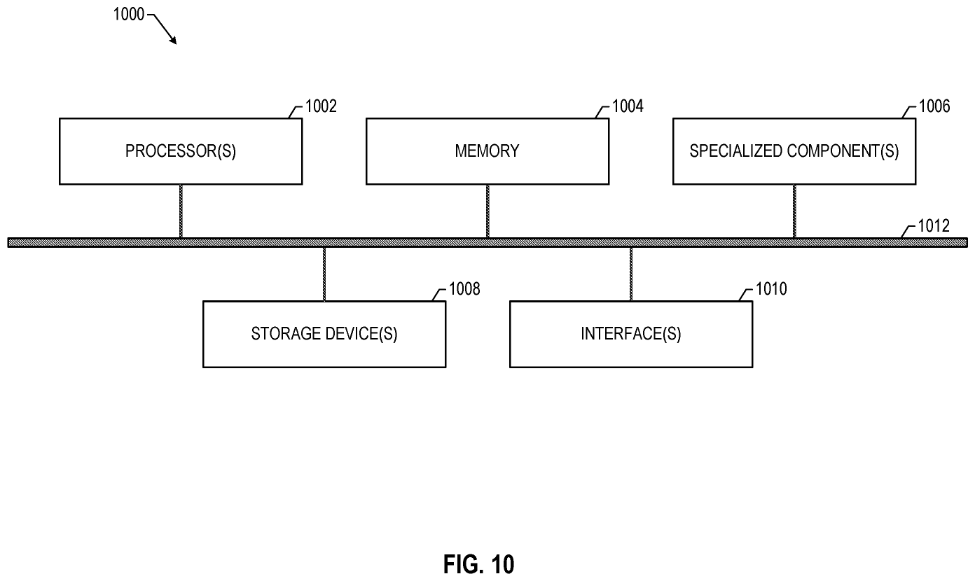

FIG. 10 provides a block diagram of an apparatus 1000 that may be used in processing (e.g., generating, receiving, sending, changing) of packets with optimized packet headers according to an embodiment. For example, in some embodiments, the apparatus 1000 may be configured to perform one or more optimization steps for generating packet headers as described herein. For example, in some embodiments, the apparatus 1000 may be configured to generate the IDs (e.g., the shortened IP addresses) as described herein. In some embodiments, the apparatus 1000 may be configured to send and/or receive packets with optimized packet headers as described herein. In some embodiments, the apparatus may be configured to access packets with optimized packet headers and convert information therein to that corresponding to conventional packet headers (e.g., to reverse the one or more optimizations applied to shorten the packet headers for transmission).

As shown in FIG. 10, in some embodiments, the apparatus 1000 may include one or more processor(s) 1002, memory 1004, one or more specialized component(s) 1006 (e.g., hardware configured for performing operations related to processing optimized packet headers as described herein), storage device(s) 1008, and interface(s) 1010 for communicating information (e.g., sending and receiving packets, user-interfaces, displaying information, etc.), which are typically communicatively coupled via one or more communications mechanisms 1012 (e.g., a bus), with the communications paths typically tailored to meet the needs of the application.

Various embodiments of the apparatus 1000 may include more or less elements. Processing element(s) 1002 using memory 1004 and storage device(s) 1008 may control the operation of the apparatus 1000 to perform one or more tasks or processes. Memory 1004 may be one type of computer-readable/computer-storage medium, and may include random-access memory (RAM), read only memory (ROM), flash memory, integrated circuits, and/or other memory components. Memory 1004 may store computer-executable instructions to be executed by processor(s) 1002 and/or data that is manipulated by processor(s) 1002 for implementing functionality in accordance with any of the embodiments described herein. Storage device(s) 1008 may be another type of computer-readable medium, and may include solid-state storage media, disk drives, diskettes, networked services, tape drives, and other storage devices. Storage device(s) 1008 may store computer-executable instructions to be executed by processor(s) 1002 and/or data that is manipulated by processor(s) 1002 for implementing functionality in accordance with any of the embodiments described herein.

Embodiments disclosed herein may be implemented in various types of computing and networking equipment, such as switch chips, switch SoCs, switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), ICs, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores,” may be stored on a tangible, machine-readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, ASICs, digital signal processors (DSPs), etc.), embedded controllers, hardwired circuitry, and so forth.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example A1 provides an apparatus, comprising: memory storing computer-executable instructions; and one or more processors coupled to the memory and configured, when executing the computer-executable instructions, to: generate a source identifier (SID), the SID comprising a shortened representation of a source IP address, wherein the source IP address is an IP address of a source network device that is to transmit a packet to a destination network device; generate a destination identifier (DID), the DID comprising a shortened representation of a destination IP address, wherein the destination IP address is an IP address of the destination network device; and generate a packet header for the packet, wherein the SID is in a SID field of the packet header and the DID is in a DID field of the packet header.

Example A2 provides the apparatus according to example A1, wherein the shortened representation of the source IP address is based on a first subset of the source IP address and a shortened representation of a second subset of the source IP address, and the first subset and the second subset are non-overlapping subsets of consecutive bits of the source IP address.

Example A3 provides the apparatus according to example A2, wherein the shortened representation of the source IP address includes the shortened representation of the second subset of the source IP address appended to the first subset.

Example A4 provides the apparatus according to examples A2 or A3, wherein the first subset includes lower order bits of the source IP address than the second subset.

Example A5 provides the apparatus according to any one of the preceding examples A, wherein the SID field is less than 32 bits and/or the DID field is less than 32 bits.

Example A6 provides the apparatus according to any one of the preceding examples A, wherein the packet header further includes a further field to store a shortened representation of a type of encapsulation protocol for the packet, and the further field is less than 8 bits.

Example A7 provides the apparatus according to any one of the preceding examples A, wherein an IPG field of the packet is less than 96 bits.

Example A8 provides the apparatus according to any one of the preceding examples A, wherein an IPG field of the packet is equal to or less than 32 bits.

Example A9 provides the apparatus according to any one of the preceding examples A, wherein the packet header does not include a MAC address of the source network device or the packet header does not include a MAC address of the destination network device.

Example A10 provides the apparatus according to any one of the preceding examples A, wherein the apparatus is one or more of, is included in one or more of, or includes one or more of: a NIC, a remote DMA (RDMA)-enabled NIC, a SmartNIC, a router, a switch, a forwarding element, an IPU, or a DPU.

Example A11 provides a computer-implemented method to be performed at an apparatus of a computing node of a computing network, the method comprising: generating a source identifier (SID), the SID comprising a shortened representation of a source IP address, wherein the source IP address is an IP address of a source network device that is to transmit a packet to a destination network device; generating a destination identifier (DID), the DID comprising a shortened representation of a destination IP address, wherein the destination IP address is an IP address of the destination network device; and generating a packet header for the packet, wherein the SID is in a SID field of the packet header and the DID is in a DID field of the packet header.

Example A12 provides the computer-implemented method according to example A11, wherein the shortened representation of the source IP address is based on a first subset of the source IP address and a shortened representation of a second subset of the source IP address, and the first subset and the second subset are non-overlapping subsets of consecutive bits of the source IP address.

Example A13 provides the computer-implemented method according to example A12, wherein the shortened representation of the source IP address includes the shortened representation of the second subset of the source IP address appended to the first subset.

Example A14 provides the computer-implemented method according to examples A12 or A13, wherein the first subset includes lower order bits of the source IP address than the second slides.

Example A15 provides the computer-implemented method according to any one of examples A11-14, wherein the SID field is less than 32 bits and/or the DID field is less than 32 bits.

Example A16 provides the computer-implemented method according to any one of examples A11-15, wherein the packet header further includes a further field to store a shortened representation of a type of encapsulation protocol for the packet, and the further field is less than 8 bits.

Example A17 provides the computer-implemented method according to any one of examples A11-16, wherein an IPG field of the packet is less than 96 bits.

Example A18 provides the computer-implemented method according to any one of examples A11-17, wherein an IPG field of the packet is equal to or less than 32 bits.

Example A19 provides the computer-implemented method according to any one of examples A11-18, wherein the packet header does not include a MAC address of the source network device.

Example A20 provides the computer-implemented method according to any one of examples A11-19, wherein the packet header does not include a MAC address of the destination network device.

Example A21 provides an apparatus of a server of a computing network, the computing network including a host memory and a network interface device, the apparatus including one or more processors to carry out a computer-implemented method according to any one of examples A11-20.

Example A22 provides a server of a computing network, the computing network including a host memory and a network interface device, the server including a plurality of cache memory circuitries, and one or more processors coupled to the cache memory circuitries, the one or more processors to carry out a computer-implemented method according to any one of examples A11-20.

Example A23 provides an apparatus of a network interface device of a computing network, the computing network including a host memory and a server, the apparatus including a circuitry to carry out a computer-implemented method according to any one of examples A11-20.

Example A24 provides a network interface device of a computing network, the computing network including a host memory and a server, the network interface device including a host interface to communicate with a server, and further including a circuitry coupled to the host interface to carry out a computer-implemented method according to any one of examples A11-20.

Example A25 provides a computer program comprising the instructions to carry out a computer-implemented method according to any one of examples A11-20.

Example A26 provides an Application Programming Interface defining functions, methods, variables, data structures, and/or protocols for the instructions of a computer-implemented method according to any one of examples A11-20.

Example A27 provides an apparatus comprising circuitry loaded with the instructions to carry out a computer-implemented method according to any one of examples A11-20.

Example A28 provides an apparatus comprising circuitry operable to run the instructions to carry out a computer-implemented method according to any one of examples A11-20.

Example A29 provides an integrated circuit comprising one or more of the processor circuitries to carry out a computer-implemented method according to any one of examples A11-20.

Example A30 provides a computing system comprising the one or more computer-readable media to carry out a computer-implemented method according to any one of examples A11-20.

Example A31 provides an apparatus comprising means for executing a computer-implemented method according to any one of examples A11-20.

Example A32 provides a signal generated as a result of executing the instructions to carry out a computer-implemented method according to any one of examples A11-20.

Example A33 provides a data unit generated as a result of executing the instructions to carry out a computer-implemented method according to any one of examples A11-20.

Example A34 provides a data unit according to example A33, wherein the data unit is a datagram, packet, data frame, data segment, a Protocol Data Unit (PDU), a Service Data Unit (SDU), a message, or a database object.

Example A35 provides a signal encoded with the data unit according to any one of examples A33-34.

Example A36 provides a n electromagnetic signal carrying the instructions to carry out a computer-implemented method according to any one of examples A11-20.

Example A37 provides a non-transitory machine-readable storage medium including machine-readable instructions which, when executed, implement a computer-implemented method according to any one of examples A11-20.

Example A38 provides a distributed edge computing system comprising: a central server; a plurality of computing nodes communicably coupled to the central server, at least one of the computing nodes including one or more processors and instructions that, when executed by the one or more processors, cause the at least one of the computing nodes to perform operations to carry out a computer-implemented method according to any one of examples A11-20.

Example A39 provides a packet, comprising a packet header and a payload, wherein the packet header includes and identifier field to store a shortened representation of an IP address of a network device, wherein the network device is either a network device to send the packet or a network device to receive the packet.

Example A40 provides the packet according to example A39, wherein the shortened representation of the IP address is based on a first subset of the IP address and a shortened representation of a second subset of the IP address, and the first subset and the second subset are non-overlapping subsets of consecutive bits of the IP address.

Example A41 provides the packet according to example A40, wherein the shortened representation of the IP address includes the shortened representation of the second subset of the IP address appended to the first subset.

Example A42 provides the packet according to examples A40 or A41, wherein the first subset includes lower order bits of the IP address than the second slides.

Example A43 provides the packet according to any one of examples A39-43, wherein the identifier field is less than 32 bits.

Example A44 provides the packet according to any one of examples A39-44, wherein the packet header further includes a further field to store a shortened representation of a type of encapsulation protocol for the packet, and the further field is less than 8 bits.

Example B1 provides an apparatus, including one or more processors configured, when executing computer-executable instructions, to generate a packet header for a packet from a source network device to a destination network device, where: the packet header includes a field including a source identifier (SID), the SID including a shortened representation of a complete IP address of the source network device, a field including a destination identifier (DID), the DID including a shortened representation of a complete IP address of the destination network device, and a field having a total number of bits that is less than 8 and including a shortened representation of a type of encapsulation protocol for the packet, and the packet header excludes: a field including the complete IP address of the source network device, a field including the complete IP address of the destination network device, a field including a MAC address of the source network device, a field including a MAC address of the destination network device, a field including a header checksum, and a field including a total size of the packet.

Example B2 provides the apparatus according to example B1, where generating the packet header includes generating the SID by: obtaining an output of a lookup table generated based on providing to the lookup table a first subset of the complete IP address of the source network device and a second subset of the complete IP address of the source network device, the output including N bits, and generating the SID as M lowest order bits of the output appended to a third subset of the complete IP address of the source network device, where M is an integer smaller than N, and the first subset, the second subset, and the third subset are non-overlapping subsets of consecutive bits of the complete IP address of the source network device.

Example B3 provides the apparatus according to example B2, where the third subset includes lower order bits of the complete IP address of the source network device than the first subset.

Example B4 provides the apparatus according to example B3, where the third subset includes lower order bits of the complete IP address of the source network device than the second subset.

Example B5 provides the apparatus according to any one of the preceding examples B, where the packet header further excludes a field including an Ether type.

Example B6 provides the apparatus according to any one of the preceding examples B, where the field including the shortened representation of the type of encapsulation protocol for the packet is a 4-bit field.

Example B7 provides the apparatus according to any one of the preceding examples B, where the field including the SID is less than 32 bits and/or the field including the DID is less than 32 bits.

Example B8 provides the apparatus according to any one of the preceding examples B, where the field including the SID is equal to or less than 24 bits and/or the field including the DID is equal to or less than 24 bits.

Example B9 provides the apparatus according to any one of the preceding examples B, where an IPG field of the packet is less than 96 bits.

Example B10 provides the apparatus according to any one of the preceding examples B, where an IPG field of the packet is equal to or less than 32 bits.

Example B11 provides an apparatus, including one or more processors configured to: generate a source identifier (SID), the SID including a shortened representation of a source IP address, where the source IP address is an IP address of a source network device that is to transmit a packet to a destination network device, and generate a header for the packet, where the SID is in a SID field of the header, where generating the SID includes obtaining an output of a lookup table generated based on providing to the lookup table a first subset of the source IP address and a second subset of the source IP address, the output including N bits, and generating the SID as M lowest order bits of the output appended to a third subset of the source IP address, where: M is an integer smaller than N, the first subset, the second subset, and the third subset are non-overlapping subsets of consecutive bits of the source IP address, and the third subset includes lower order bits of the source IP address than the first subset and the second subset.

Example B12 provides the apparatus according to example B11, where: the header further includes a further field to store a shortened representation of a type of encapsulation protocol for the packet, and the further field is a 4-bit field.

Example B13 provides the apparatus according to any one of examples B11-12, where the header does not include a field containing an Ether type.

Example B14 provides the apparatus according to any one of examples B11-13, where the header does not include a field containing a header checksum.

Example B15 provides the apparatus according to any one of examples B11-14, where the header does not include a MAC address of the source network device.

Example B16 provides the apparatus according to any one of examples B11-15, where: the one or more processors are further configured to: generate a destination identifier (DID), the DID including a shortened representation of a destination IP address, where the destination IP address is an IP address of the destination network device, and include the DID in a DID field of the header, where generating the DID includes obtaining a further output of the lookup table generated based on providing to the lookup table a first subset of the destination IP address and a second subset of the destination IP address, the further output including L bits, and generating the DID as K lowest order bits of the output appended to a third subset of the destination IP address, where: K is an integer smaller than L, the first subset of the destination IP address, the second subset of the destination IP address, and the third subset of the destination IP address are non-overlapping subsets of consecutive bits of the destination IP address, and the third subset of the destination IP address includes lower order bits of the destination IP address than the first subset of the destination IP address and the second subset of the destination IP address.

Example B17 provides the apparatus according to example B16, where the header does not include a MAC address of the destination network device.

Example B18 provides the apparatus according to examples B16 or 17, where the field including the DID is equal to or less than 24 bits.

Example B19 provides an apparatus, including one or more processors configured to generate a packet header for a packet from a source network device to a destination network device, where the packet header includes one or more bits indicating the packet header includes a proper subset of Ethernet and IPv4 header fields. The packet header further includes the proper subset of Ethernet and IPv4 header fields, the proper subset including a field including a source identifier (SID), the SID including a shortened representation of a complete IP address of the source network device, a field including a destination identifier (DID), the DID including a shortened representation of a complete IP address of the destination network device, and a field having a total number of bits that is less than 8 and including a shortened representation of a type of encapsulation protocol for the packet, where the proper subset of Ethernet and IPv4 header fields does not include: a field including the complete IP address of the source network device, a field including the complete IP address of the destination network device, a field including a MAC address of the source network device, a field including a MAC address of the destination network device, a field including a header checksum, and a field including a total size of the packet.

Example B20 provides the apparatus according to example B19, where generating the packet header includes generating the SID by: obtaining an output of a lookup table generated based on providing to the lookup table a first subset of the complete IP address of the source network device and a second subset of the complete IP address of the source network device, the output including N bits, and generating the SID as M lowest order bits of the output appended to a third subset of the complete IP address of the source network device, where: M is an integer smaller than N, the first subset, the second subset, and the third subset are non-overlapping subsets of consecutive bits of the complete IP address of the source network device, and the third subset includes lower order bits of the complete IP address of the source network device than the first subset and the second subset.

Example B21 provides the apparatus according to any one of examples B1-20, where the apparatus is one of: a NIC, a remote DMA (RDMA)-enabled NIC, a SmartNIC, a router, a switch, a forwarding element, an IPU, or a DPU.

Example B22 provides the apparatus according to any one of examples B1-20, where the apparatus is a NIC.

Example B23 provides the apparatus according to any one of examples B1-20, where the apparatus is a switch and further includes a port for receiving the packet or a port for transmitting the packet.

Example B24 provides the apparatus according to example B23, where the apparatus further includes a memory coupled to the one or more processors.

Example B25 provides a computer-implemented method for generating a packet header for a packet from a source network device to a destination network device, the computer-implemented method including generating a source identifier (SID), the SID including a shortened representation of a complete IP address of the source network device; generating a destination identifier (DID), the DID including a shortened representation of a complete IP address of the destination network device; and generating the packet header, where the packet header includes a field including the SID, a field including the DID, and a field having a total number of bits that is less than 8 and including a shortened representation of a type of encapsulation protocol for the packet, and where the packet header excludes: a field including the complete IP address of the source network device, a field including the complete IP address of the destination network device, a field including a MAC address of the source network device, a field including a MAC address of the destination network device, a field including a header checksum, and a field including a total size of the packet.

Example B26 provides the computer-implemented method according to example B25, where generating the packet header includes generating the SID by: obtaining an output of a lookup table generated based on providing to the lookup table a first subset of the complete IP address of the source network device and a second subset of the complete IP address of the source network device, the output including N bits, and generating the SID as M lowest order bits of the output appended to a third subset of the complete IP address of the source network device, where M is an integer smaller than N, and the first subset, the second subset, and the third subset are non-overlapping subsets of consecutive bits of the complete IP address of the source network device.

Example B27 provides the computer-implemented method according to example B26, where the third subset includes lower order bits of the complete IP address of the source network device than the first subset.

Example B28 provides the computer-implemented method according to example B27, where the third subset includes lower order bits of the complete IP address of the source network device than the second subset.

Example B29 provides the computer-implemented method according to any one of examples B25-28, where the packet header further excludes a field including an Ether type.

Example B30 provides the computer-implemented method according to any one of examples B25-29, where the field including the shortened representation of the type of encapsulation protocol for the packet is a 4-bit field.

Example B31 provides the computer-implemented method according to any one of examples B25-30, where the field including the SID is less than 32 bits and/or the field including the DID is less than 32 bits.

Example B32 provides the computer-implemented method according to any one of examples B25-31, where the field including the SID is equal to or less than 24 bits and/or the field including the DID is equal to or less than 24 bits.

Example B33 provides the computer-implemented method according to any one of examples B25-32, where an IPG field of the packet is less than 96 bits.

Example B34 provides the computer-implemented method according to any one of examples B25-33, where an IPG field of the packet is equal to or less than 32 bits.

Example B35 provides an apparatus of a server of a computing network, the computing network including a host memory and a network interface device, the apparatus including one or more processors to carry out a computer-implemented method according to any one of examples B25-34.

Example B36 provides a server of a computing network, the computing network including a host memory and a network interface device, the server including a plurality of cache memory circuitries, and one or more processors coupled to the cache memory circuitries, the one or more processors to carry out a computer-implemented method according to any one of examples B25-34.

Example B37 provides an apparatus of a network interface device of a computing network, the computing network including a host memory and a server, the apparatus including a circuitry to carry out a computer-implemented method according to any one of examples B25-34.

Example B38 provides a network interface device of a computing network, the computing network including a host memory and a server, the network interface device including a host interface to communicate with a server, and further including a circuitry coupled to the host interface to carry out a computer-implemented method according to any one of examples B25-34.

Example B39 provides a computer program including the instructions to carry out a computer-implemented method according to any one of examples B25-34.

Example B40 provides an Application Programming Interface defining functions, methods, variables, data structures, and/or protocols for the instructions of a computer-implemented method according to any one of examples B25-34.

Example B41 provides an apparatus including circuitry loaded with the instructions to carry out a computer-implemented method according to any one of examples B25-34.

Example B42 provides an apparatus including circuitry operable to run the instructions to carry out a computer-implemented method according to any one of examples B25-34.

Example B43 provides an integrated circuit including one or more of the processor circuitries to carry out a computer-implemented method according to any one of examples B25-34.

Example B44 provides a computing system including the one or more computer-readable media to carry out a computer-implemented method according to any one of examples B25-34.

Example B45 provides an apparatus including means for executing a computer-implemented method according to any one of examples B25-34.

Example B46 provides a signal generated as a result of executing the instructions to carry out a computer-implemented method according to any one of examples B25-34.

Example B47 provides a data unit generated as a result of executing the instructions to carry out a computer-implemented method according to any one of examples B25-34.

Example B48 provides the data unit according to example B47, where the data unit is a datagram, packet, data frame, data segment, a Protocol Data Unit (PDU), a Service Data Unit (SDU), a message, or a database object.

Example B49 provides a signal encoded with the data unit according to any one of examples B47-48.

Example B50 provides an electromagnetic signal carrying the instructions to carry out a computer-implemented method according to any one of examples B25-34.

Example B51 provides a non-transitory machine-readable storage medium including machine-readable instructions which, when executed, implement a computer-implemented method according to any one of examples B25-34.

Example B52 provides a distributed edge computing system including a central server; a plurality of computing nodes communicably coupled to the central server, at least one of the computing nodes including one or more processors and instructions that, when executed by the one or more processors, cause the at least one of the computing nodes to perform operations to carry out a computer-implemented method according to any one of examples B25-34.

Example B53 provides a packet, including a header; and a payload, where the header includes and identifier field to store a shortened representation of an IP address of a network device, where the network device is either a network device to send the packet or a network device to receive the packet.

Example B54 provides the packet according to example B53, where: the shortened representation of the IP address is based on a first subset of the IP address and a shortened representation of a second subset of the IP address, and the first subset and the second subset are non-overlapping subsets of consecutive bits of the IP address.

Example B55 provides the packet according to example B54, where the shortened representation of the IP address includes the shortened representation of the second subset of the IP address appended to the first subset.

Example B56 provides the packet according to examples B54 or 55, where the first subset includes lower order bits of the IP address than the second slides.

Example B57 provides the packet according to any one of examples B53-56, where the identifier field is less than 32 bits.

Example B58 provides the packet according to any one of examples B53-57, where: the header further includes a further field to store a shortened representation of a type of encapsulation protocol for the packet, and the further field is less than 8 bits.

Example B59 provides an operating system configured to control an apparatus to function as an apparatus according to any one of examples B1-24, and/or to instruct an apparatus to be configured as an apparatus according to any one of examples B1-24.

Example B60 provides a device driver configured to control an apparatus to function as an apparatus according to any one of examples B1-24, and/or to instruct an apparatus to be configured as an apparatus according to any one of examples B1-24.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
one or more processors configured, when executing computer-executable instructions, to generate a packet header for a packet from a source network device to a destination network device, wherein:
the packet header includes:
a field comprising a source identifier (SID), the SID comprising a shortened representation of an Internet Protocol (IP) address of the source network device,
a field comprising a destination identifier (DID), the DID comprising a shortened representation of an IP address of the destination network device, and
a field having a total number of bits that is less than 8 and comprising a shortened representation of a type of encapsulation protocol for the packet, and
the packet header excludes:
a field comprising the IP address of the source network device,
a field comprising the IP address of the destination network device,
a field comprising a media access controller (MAC) address of the source network device,
a field comprising a MAC address of the destination network device,
a field comprising a header checksum, and
a field comprising a total size of the packet.

2. The apparatus according to claim 1, wherein generating the packet header includes generating the SID by:
obtaining an output of a lookup table generated based on providing to the lookup table a first subset of the IP address of the source network device and a second subset of the IP address of the source network device, the output comprising N bits, and
generating the SID as M lowest order bits of the output appended to a third subset of the IP address of the source network device, wherein M is an integer smaller than N, and the first subset, the second subset, and the third subset are non-overlapping subsets of consecutive bits of the IP address of the source network device.

3. The apparatus according to claim 2, wherein the third subset includes lower order bits of the IP address of the source network device than the first subset.

4. The apparatus according to claim 3, wherein the third subset includes lower order bits of the IP address of the source network device than the second subset.

5. The apparatus according to claim 1, wherein the packet header further excludes a field comprising an Ether type.

6. The apparatus according to claim 1, wherein the field comprising the shortened representation of the type of encapsulation protocol for the packet is a 4-bit field.

7. The apparatus according to claim 1, wherein the field comprising the SID is equal to or less than 24 bits or the field comprising the DID is equal to or less than 24 bits.

8. The apparatus according to claim 1, wherein an inter packet gap field of the packet is less than 96 bits.

9. The apparatus according to claim 1, wherein an inter packet gap field of the packet is equal to or less than 32 bits.

10. An apparatus, comprising:
one or more processors configured to:
generate a source identifier (SID), the SID comprising a shortened representation of a source Internet Protocol (IP) address, wherein the source IP address is an IP address of a source network device that is to transmit a packet to a destination network device, and
generate a header for the packet, wherein the SID is in a SID field of the header,
wherein generating the SID includes:
obtaining an output of a lookup table generated based on providing to the lookup table a first subset of the source IP address and a second subset of the source IP address, the output comprising N bits, and
generating the SID as M lowest order bits of the output appended to a third subset of the source IP address, wherein:
M is an integer smaller than N,
the first subset, the second subset, and the third subset are non-overlapping subsets of consecutive bits of the source IP address, and
the third subset includes lower order bits of the source IP address than the first subset and the second subset.

11. The apparatus according to claim 10, wherein:
the header further includes a further field to store a shortened representation of a type of encapsulation protocol for the packet, and
the further field is a 4-bit field.

12. The apparatus according to claim 10, wherein the header does not include a field containing an Ether type.

13. The apparatus according to claim 10, wherein the header does not include a field containing a header checksum.

14. The apparatus according to claim 10, wherein the header does not include a media access controller (MAC) address of the source network device.

15. The apparatus according to claim 10, wherein:
the one or more processors are further configured to:
generate a destination identifier (DID), the DID comprising a shortened representation of a destination IP address, wherein the destination IP address is an IP address of the destination network device, and
include the DID in a DID field of the header,
wherein generating the DID includes:
obtaining a further output of the lookup table generated based on providing to the lookup table a first subset of the destination IP address and a second subset of the destination IP address, the further output comprising L bits, and
generating the DID as K lowest order bits of the output appended to a third subset of the destination IP address, wherein:
K is an integer smaller than L,
the first subset of the destination IP address, the second subset of the destination IP address, and the third subset of the destination IP address are non-overlapping subsets of consecutive bits of the destination IP address, and
the third subset of the destination IP address includes lower order bits of the destination IP address than the first subset of the destination IP address and the second subset of the destination IP address.

16. The apparatus according to claim 15, wherein the header does not include a media access controller (MAC) address of the destination network device.

17. The apparatus according to claim 15, wherein the DID field is equal to or less than 32 bits.

18. An apparatus, comprising:
one or more processors configured to generate a packet header for a packet from a source network device to a destination network device, wherein the packet header includes:
one or more bits indicating the packet includes a proper subset of Ethernet and IPv4 header fields, and
the proper subset of Ethernet and IPv4 header fields, comprising:
a field comprising a source identifier (SID), the SID comprising a shortened representation of a complete Internet Protocol (IP) address of the source network device,
a field comprising a destination identifier (DID), the DID comprising a shortened representation of a complete IP address of the destination network device, and
a field having a total number of bits that is less than 8 and comprising a shortened representation of a type of encapsulation protocol for the packet,
wherein the proper subset of Ethernet and IPv4 header fields does not include:
a field comprising the IP address of the source network device,
a field comprising the IP address of the destination network device,
a field comprising a media access controller (MAC) address of the source network device,
a field comprising a MAC address of the destination network device,
a field comprising a header checksum, and
a field comprising a total size of the packet.

19. The apparatus according to claim 18, wherein generating the packet header includes generating the SID by:
obtaining an output of a lookup table generated based on providing to the lookup table a first subset of the IP address of the source network device and a second subset of the IP address of the source network device, the output comprising N bits, and
generating the SID as M lowest order bits of the output appended to a third subset of the IP address of the source network device, wherein:
M is an integer smaller than N,
the first subset, the second subset, and the third subset are non-overlapping subsets of consecutive bits of the IP address of the source network device, and
the third subset includes lower order bits of the IP address of the source network device than the first subset and the second subset.

20. The apparatus according to claim 18, wherein the packet header further includes a field indicating a type of the proper subset of Ethernet and IPv4 header fields included in the packet header.
